(19) United States
(12) Patent Application Publication
(10) Pub. No.: US 2026/0228432 A1
(43) Pub. Date: Aug. 6, 2026

(54) METHOD FOR PROCESSING AERONAUTICAL INFORMATION INTENDED FOR FLIGHT CREWS

(71) Applicant: THALES, MEUDON (FR)

(72) Inventors: Florent CHENEVIER, TOULOUSE (FR); Amandine AUDOUY, TOULOUSE (FR); Eric BLAUDEZ, TOULOUSE (FR); Claire LAUDY, TOULOUSE (FR)

(21) Appl. No.: 19/127,409

(22) PCT Filed: Nov. 13, 2023
(86) PCT No.: PCT/EP2023/081570

§ 371 Date: May 5, 2025

(30) Foreign Application Priority Data
Nov. 17, 2022 (FR) FR2211938

(51) Int. Cl. G06F 40/295; G06F 16/23; G06F 16/28; G06F 40/166; G06F 40/253; G08G 5/265

(52) U.S. Cl. CPC G06F 40/295; G06F 16/2365; G06F 16/285; G06F 16/288; G06F 40/166; G06F 40/253; G08G 5/265

(57) ABSTRACT

A method for processing aeronautical information intended for flight crews, is implemented by computer and intended to populate a digital database which is able to be interrogated by a user, the aeronautical information including text messages represented by digital data, the method including a step of receiving the messages, and for each message: a step of determining named entities contained in the message and the relationships between these the named entities, and a step of integrating the named entities and their relationships into a database in the form of knowledge graphs.

### CROSS-REFERENCE TO RELATED APPLICATIONS

This application is a National Stage of International patent application PCT/EP2023/081570, filed on Nov. 13, 2023, which claims priority to foreign French patent application No. FR 2211938, filed on Nov. 17, 2022, the disclosures of which are incorporated by reference in their entireties.

### FIELD OF THE INVENTION

The invention relates to the field of aeronautical information intended for flight crew, and, in particular, to a method for processing such information.

### BACKGROUND

Aeronautical information, such as NOTAMs (for “Notice to Airmen”), is known. A NOTAM is a text message generally in the English language issued by a civil aviation authority for the attention of flight crew. Typically, a NOTAM comprises information relating to air transport infrastructure, such as airports for example; airspace; services offered, such as hotels, fuel supply; or regulations, customs. This information may provide information about their status, their availability, usage restrictions or procedural changes. A NOTAM may also comprise information about natural phenomena, for example about weather conditions or volcanic activity. A NOTAM amends official publications such as maps and procedures. It is generally temporary in that it describes a current state which is likely to change. However, permanent NOTAMs do exist.

FIG. 1 illustrates an example of a NOTAM. Aviation organizations have defined a structure that each NOTAM must have. NOTAMs are written with abbreviations or acronyms specific to aviation, an official list of which is maintained by the International Civil Aviation Organization (ICAO). The NOTAM forms a structured text message using capital letters, generally at the beginning of each paragraph, which indicate the type of information mentioned. A second level of structuring is defined by the symbol “/” which creates an information separator. Thus, the first line of the message represents the following information: NOTAM serial number/year. The first line ends with the indication that it is a NOTAM.

The following letters each indicate a type of information:
i. Q): qualification line which provides context elements; in particular, the element located between the first and the second symbol “/” provides the “Qcode” which provides information about the general subject of the message according to predefined categories;
ii. A): the location;
iii. B): the start date of activity, that is to say the start date of application of the NOTAM;
iv. C): the end date of activity, that is to say the end date of application of the NOTAM;
v. D): the activity window, that is to say the hours of application of the NOTAM;
vi. E): the information which is the main subject of the NOTAM; this is a text freely written by the editor;
vii. F) lower limit of activity, that is to say the minimum altitude to which the NOTAM applies;
viii. G) upper limit of activity, that is to say the maximum altitude to which the NOTAM applies.

These NOTAMs are in particular intended for pilots who must consult them to prepare for their flight. To be relevant, such a review of the NOTAMs must take place in a period immediately preceding the flight, generally within the two hours preceding it. This review is done in addition to other activities that a pilot is required to do before their flight, this making it difficult for them to conduct a comprehensive analysis of the NOTAMS. This is all the more the case given that a pilot may have to consult dozens of them.

Furthermore, it may be difficult for the pilot to classify them and prioritize them by criticality for their flight in an efficient manner. This is because official abbreviations and acronyms must be decoded, and the editor of the NOTAM uses a telegraphic style with additional abbreviations and omissions of words. The Q-code, which is supposed to provide information about the main subject of the NOTAM, may take a large number of values, around 1200. Furthermore, this field is not always correctly filled in by the person writing the NOTAM.

A technical solution which makes it possible to extract relevant information from the NOTAMs therefore proves to be particularly advantageous for users. In particular, the publication “Interpretation et visualisation contextuelle de NOTAMs (messages aux navigants aériens)” [Interpretation and contextual visualization of NOTAMs (notices to airmen)], A. Arnold, G. Dupont, C. Kobus, F. Lancelot, P. Narayan, 26th Conference on the Automatic Processing of Natural Languages, Toulouse, France, ATALA, p.639-643, 2019, is known. This document describes a method for processing a NOTAM in order to visualize the information contained therein on an airport card. However, it lacks a method for processing the NOTAMs which is generic and which makes it possible to obtain a database which is able to be interrogated by a user.

Other aeronautical information, such as supplements to aeronautical information publications, called SUP AIPs, is known. Such aeronautical information amends aeronautical information publications (AIPs). Typically, like NOTAMs, SUP AIPs have a temporary nature.

A method for processing aeronautical information, such as NOTAMs or SUP AIPs, which makes it possible to extract information therefrom in order to make it available to a user is therefore sought.

### SUMMARY OF THE INVENTION

To this end, the invention proposes a method for processing aeronautical information intended for flight crews, implemented by computer and intended to populate a digital database which is able to be interrogated by a user, said aeronautical information comprising text messages represented by digital data, said method comprising a step of receiving the messages, and for each message:
a step of determining named entities contained in the message and the relationships between these said named entities,
a step of integrating said named entities and their relationships into a database in the form of knowledge graphs.

The representation in the form of knowledge graphs facilitates the analysis of the information extracted from the aeronautical information messages and its ability to be retrieved and prioritized by a user.

According to one embodiment, the method comprises, after the receiving step, a step of translating the messages into natural language.

According to one variant, said translating step comprises, in a message:
replacing abbreviations with their meaning, or
adding missing verbs, or
adding missing conjunctions, or
replacing regular expressions with their meaning.

According to one variant, the method comprises, before the translating step, a classifying step which comprises:
classifying the message according to a base of message types, and
determining the subjects dealt with in said message on the basis of a base of keywords,
said translating step being a function of the classification of the message and of the subjects dealt with in said message.

According to one embodiment, the method comprises, after the translating step:
a segmentation step comprising segmenting the message into a list of words for comparison with a vocabulary,
a grammatical analysis step comprising attributing to each word a label representative of its grammatical position,
a step of extracting named entities and their relationships,
a step of building a knowledge graph on the basis of the named entities and their relationships.

According to one embodiment, the method comprises a step of detecting inconsistencies between the knowledge graphs of the database.

According to one embodiment, the method comprises merging the knowledge graphs which are at least partially identical.

According to one embodiment, the method comprises, before said step of receiving messages:
a request for aeronautical information by a member of flight crew on an aeronautical database, in particular aeronautical information in relation to one or more geographical areas;
sending said aeronautical information on a computer.

According to one embodiment, the text messages of the aeronautical information comprise messages to flight crew, called “NOTAMs”, and/or supplements to aeronautical information publications, called SUP AIPs.

### BRIEF DESCRIPTION OF THE DRAWINGS

Other features and advantages of the present invention will become clearer on reading the following description in relation to the following appended figures:

FIG. 1 already described, shows an example of a NOTAM;

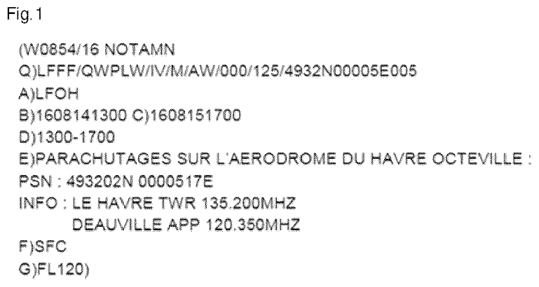

FIG. 2 shows the steps of an example of a method according to the invention;

FIG. 3 shows the preprocessing of a NOTAM in the example of a method of FIG. 2;

FIG. 4 shows an example of an ontology of concepts able to be used in the example of a method illustrated in FIG. 2.

### DETAILED DESCRIPTION

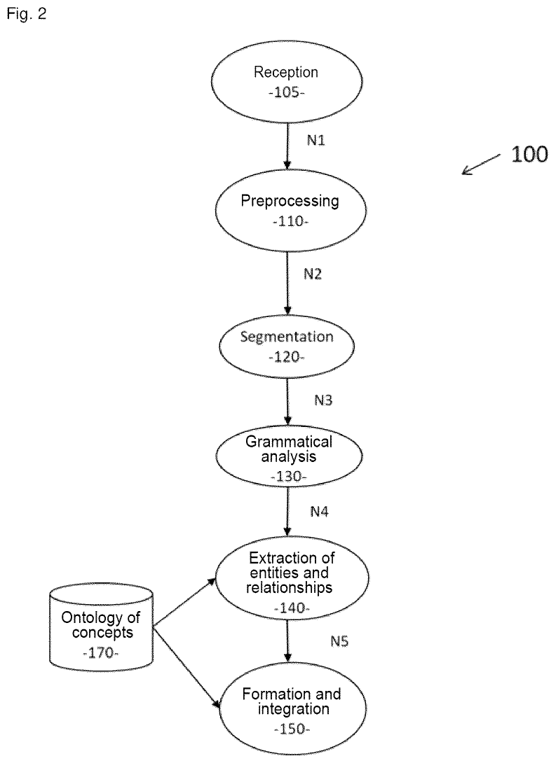

FIG. 2 illustrates an example of a method 100 for processing aeronautical information according to the invention. The method is implemented by a computer to populate a digital database which is able to be interrogated by a user, in particular a pilot. The aeronautical information comprises text messages represented by digital data.

In particular, a member of flight crew such as a pilot issues a request for aeronautical information on an aeronautical database. In particular, such a request aims to obtain NOTAMs or SUP AIPs in relation to one or more geographical areas concerned by a flight plan of the member of flight crew. In a step 105, the aeronautical information is then received on a computer.

The aeronautical information, in particular the NOTAMs and/or SUP AIPs, are processed together in order to be integrated into a database in the form of knowledge graphs. Hereinbelow, an example of processing aeronautical information of NOTAM type is explained. However, the explanations apply similarly to other types of aeronautical information, such as SUP AIPs. In the context of the present application, NOTAM designates the text message received but also its various intermediate states obtained during the implementation of the example of a method according to the invention.

Primarily, for each NOTAM received, the named entities, as well as the relationships between them, are determined. These entities and relationships between them are formalized in the form of knowledge graphs in a database. The NOTAMs processed by the method 100 are all integrated into the same database. For example, all the NOTAMs which have to be reviewed by a pilot are integrated into the same database in the form of knowledge graphs. The method comprises automatic processing of a plurality of NOTAMs to obtain a semantic representation of the world which is able to be used for the pilot's mission. The representation in the form of a knowledge graph makes it possible to sort and prioritize the knowledge contained in the NOTAMs for use by the pilot. This sorting and this prioritization may be updated during the pilot's mission as mission parameters change so as to produce recommendations for the pilot.

In order to facilitate the formalization into a knowledge graph, the method may comprise an initial step 110 of preprocessing the NOTAM, which consists in particular of a translation or conversion of the raw NOTAM N1 into natural, syntactically correct language. The term “natural language” is understood to mean a normal language commonly used by a human being, as opposed to a formal language, such as a computer language.

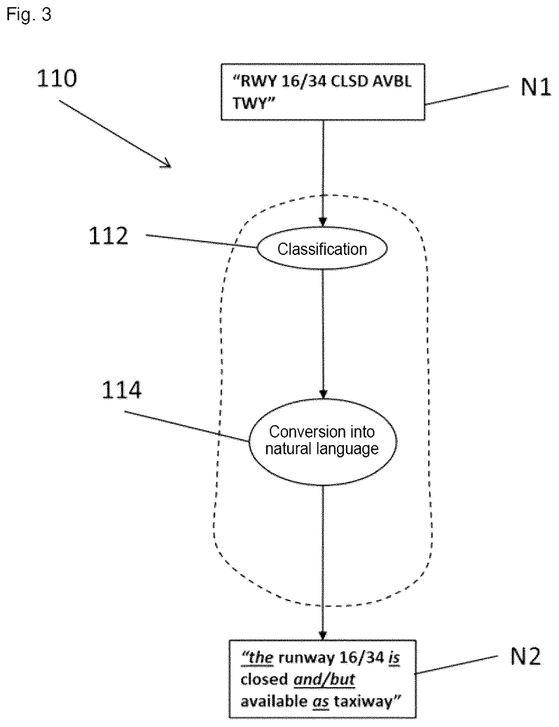

The preprocessing step 110 is illustrated in FIG. 3. The raw NOTAM N1 is received at the input of the method and is in particular as issued by an aviation authority. The illustrated example of a raw NOTAM N1 comprises the following text:
“RWY 16/34 CLSD AVBL TWY”

Here, only the text following the letter E) of the NOTAM is shown. During this preprocessing 110, in a step 114 of converting into natural language, the raw text of the NOTAM is modified so as to replace the abbreviations with their meaning, namely a word or an expression designated by this abbreviation. Missing verbs or conjunctions are added. It is also possible to recognize and replace regular expressions (sequence of known characters) by their meaning, namely a word or expression belonging to the natural language. Thus, at the end of this translating step, the NOTAM N2 comprises the following text, the added words being underlined.
“the runway 16/34 is closed and/but available as taxiway”

Such a step 114 of converting into natural language facilitates the subsequent steps of processing the NOTAM which will be described later in relation to FIG. 2. A number of tools for translating into natural language exist. Use may be made of, among others, deep learning models, such as, for example, so-called “transformer” models GPT2, GPT3.

Prior to translation, the preprocessing step 110 may comprise a step 112 of classifying the NOTAM.

In particular, the NOTAM is then classified according to a base of NOTAM types so as to know the general subject of the NOTAM. Such a classification may be based on the content of the Q-code, in particular on a reconstruction of the Q-code using a natural language processing tool. Such a reconstruction makes it possible to compensate for poor writing by the issuer of the NOTAM. Knowing the general subject of the message may facilitate the subsequent step 114 of converting into natural language. The NOTAM may also be classified according to its language level. For example, from zero, for a text comprising mostly abbreviations, to five, for a text already in natural language. The subjects dealt with in the NOTAM may also be determined on the basis of a base of keywords.

At the end of this preprocessing step 110, the NOTAM N2 in natural language undergoes a series of steps, illustrated in FIG. 2, in order to be represented in the form of knowledge graphs. In particular, the NOTAM N2 undergoes a segmentation step 120 comprising segmenting the NOTAM into a list of words for comparison with a vocabulary. Then a grammatical analysis 130 is applied to the NOTAM N3, comprising attributing to each word a label representative of its grammatical position. Annotated phrases are then obtained. During a step 140, the named entities and their relationships are then extracted from the NOTAM N4 in the form of N-tuples N5. On the basis thereof, the knowledge graph is then built in a step 150.

The step 140 of extracting entities and relationships and the step 150 of building a knowledge graph may be supported by an ontology of concepts 170 specific to aeronautical information, for example to NOTAMs and/or to SUP AIPs.

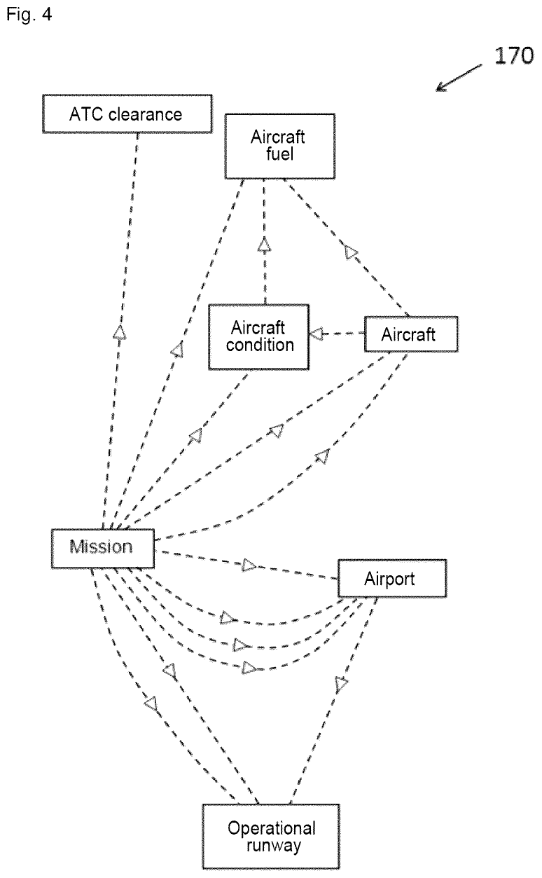

FIG. 4 shows an example of a concept ontology in which the attributes related to the concept of the mission are represented: the attributes comprise the following items: ATC (Air Traffic Control) clearance, aircraft fuel, aircraft condition, aircraft, airport, operational runway.

The representation in knowledge graphs makes it possible to detect inconsistencies between information originating from the aeronautical information, and makes it possible to merge knowledge graphs which provide the same information. Such merging of graphs may be obtained by a maximal subgraph isomorphism search method.

Knowledge graphs which are at least partially identical may be merged. Thus, two knowledge graphs may be compared. If a subset of nodes and relationships is identical in the two graphs, only one instance of this subset is integrated into the database.

1. A method for processing aeronautical information intended for flight crews, implemented by computer and intended to populate a digital database which is able to be interrogated by a user, said aeronautical information comprising text messages represented by digital data, said method comprising a step of receiving the messages, a step of translating the messages into natural language, and for each message:
a step of determining named entities contained in the message and the relationships between these said named entities,
a step of integrating said named entities and their relationships into a database in the form of knowledge graphs.

2. The method as claimed in claim 1, wherein said translating step comprises, in a message:
replacing abbreviations with their meaning, or
adding missing verbs, or
adding missing conjunctions, or
replacing regular expressions with their meaning.

3. The method as claimed in claim 2, comprising, before the translating step a classifying step which comprises:
classifying the message according to a base of message types, and
determining the subjects dealt with in said message on the basis of a base of keywords,
said translating step being a function of the classification of the message and of the subjects dealt with in said message.

4. The method as claimed in claim 1, comprising, after the translating step:
a segmentation step comprising segmenting the message into a list of words for comparison with a vocabulary,
a grammatical analysis step comprising attributing to each word a label representative of its grammatical position,
a step of extracting named entities and their relationships,
a step of building a knowledge graph on the basis of the named entities and their relationships.

5. The method as claimed in claim 1, comprising a step of detecting inconsistencies between the knowledge graphs of the database.

6. The method as claimed in claim 1, comprising merging the knowledge graphs which are at least partially identical.

7. The method as claimed in claim 1, comprising, before said step of receiving messages:
a request for aeronautical information by a member of flight crew on an aeronautical database, in particular aeronautical information in relation to one or more geographical areas;
sending said aeronautical information on a computer.

8. The method as claimed in claim 1, wherein the text messages of the aeronautical information comprise messages to flight crew, called “NOTAMs”, and/or supplements to aeronautical information publications, called SUP AIPs.
